(19) United States
(12) Patent Application Publication
(10) Pub. No.: US 2024/0218139 A1
(43) Pub. Date: Jul. 4, 2024

(54) POLYURETHANE COATED POLYOLEFIN FILM AND METHOD FOR MAKING IT

(71) Applicants: Dow Global Technologies LLC, Midland, MI (US); Rohm and Haas Company, Collegeville, PA (US)

(72) Inventors: Gaobing Chen, Shanghai (CN); Chenyan Bai, Shanghai (CN); Jianping Pan, Shanghai (CN); Jie Wu, Pearland, TX (US); Juan Carlos Casarrubias, Mexico City (MX)

(21) Appl. No.: 18/288,943

(22) PCT Filed: Jun. 7, 2021
(86) PCT No.: PCT/CN2021/098559

§ 371 Date: Oct. 30, 2023

(51) Int. Cl. C08J 7/04; C09D 175/04

(52) U.S. Cl. CPC C08J 7/0427; C09D 175/04; C08J 2323/06; C08J 2323/12; C08J 2323/20; C08J 2475/04

(57) ABSTRACT

Provided herein is a laminate, comprising a polyolefin-based substrate film having a first inner surface and a first outer surface, and a polyurethane-based top coating having a second inner surface and a second outer surface, wherein the first inner surface is in contact with the second inner surface, wherein the polyurethane-based top coating is formed by mixing an isocyanate-terminated component and a hydroxyl-terminated component and coating the mixture onto the first inner surface of the polyolefin-based substrate film. Also provided are methods of preparing the laminate, articles comprising the laminate and use of the laminate in the packaging of a product.

### FIELD OF THE DISCLOSURE

The present disclosure relates generally to the field of packaging materials, and in particular, to laminates useful for packaging and articles comprising the same.

### BACKGROUND

Packaging is an important part of a product. It is a coordinated system of preparing goods for transport, warehousing, logistics, sale, which normally needs good softness, clarity as well as scratch resistance. So far the market is dominated by PVC films, which can deliver acceptable properties for packaging applications, but the industry has raised concerns about the chloride content, high stiffness and relatively poor clarity of PVC films.

There exist continuous needs for novel packaging materials that may have a desired combination of properties not available from the existing packaging film products (for example, PVC packaging films).

### SUMMARY OF THE DISCLOSURE

Embodiments of the present disclosure meet the needs by providing a laminate comprising a polyolefin-based substrate film coated with a polyurethane-based top coating film. It has been found that the laminate according to the present disclosure brings improved balancing of performances including good softness, clarity and scratch resistance, with reduced chloride content.

In an aspect, the present disclosure provides a laminate comprising: a polyolefin-based substrate film having a first inner surface and a first outer surface, and a polyurethane-based top coating having a second inner surface and a second outer surface, wherein the first inner surface is in contact with the second inner surface, wherein the polyurethane-based top coating is formed by mixing an isocyanate-terminated component and a hydroxyl-terminated component and coating the mixture onto the first inner surface of the polyolefin-based substrate film, and wherein the laminate has a Zebedee clarity of no lower than 25% as measured in accordance with ASTM D1746/15, and a tensile modulus of no higher than 230 MPa as measured in accordance with ASTM D882.

In a further aspect, the present disclosure provides a method of preparing a laminate as described herein, comprising: (1) providing the polyolefin-based substrate film having a first inner surface and a first outer surface; (2) mixing the isocyanate-terminated component and the hydroxyl-terminated component to form a mixture; and (3) coating, on the first inner surface, the mixture obtained in step (2), to form a layer of the polyurethane-based top coating having a second inner surface and a second outer surface.

In a further aspect, the present disclosure provides an article comprising the laminate described herein.

In a further aspect, the present disclosure provides use of the laminate described herein in the packaging of a product.

It is to be understood that both the foregoing general description and the following detailed description are exemplary and explanatory only and are not restrictive of the invention, as claimed.

### BRIEF DESCRIPTION OF THE DRAWINGS

FIG. 1 shows the results of the scratch resistance test.

### DETAILED DESCRIPTION OF THE DISCLOSURE

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated.

As disclosed herein, the terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed.

As disclosed herein, all percentages mentioned herein are by weight, and temperatures in degree centigrade (° C.), unless specified otherwise.

### A. Laminates

Laminates of the present disclosure comprise a polyolefin-based substrate film and a polyurethane-based top coating.

The polyolefin-based substrate film has a first outer surface and a first inner surface facing the polyurethane-based top coating, and, the polyurethane-based top coating has a second outer surface and a second inner surface facing the polyolefin-based substrate film. In some embodiments, the first inner surface can be at least partially or wholly in contact with the second inner surface. In some embodiments, the first inner surface can be in contact with the entire second inner surface.

i. Polyolefin-Based Substrate Film

The polyolefin-based substrate film is formed essentially of polyolefin. In some embodiments, the polyolefin-based substrate film comprises from 50% to 100%, from 55% to 100%, or from 60% to 100% by weight of a polyolefin, based on the total weight of the polyolefin-based substrate film.

The terms “polyolefin” and “olefin-based polymer” can be used interchangeably herein and refer to a polymer that comprises, in polymerized form, equal to or higher than 50 wt % or a majority weight percent of olefin(s) (based on the weight of the polymer), and optionally may comprise one or more co-monomers.

The terms “polyethylene” and “ethylene-based polymer” can be used interchangeably herein and refer to a polymer that comprises, in polymerized form, equal to or higher than 50 wt % or a majority weight percent of ethylene (based on the weight of the polymer), and optionally may comprise one or more comonomers. The terms “polypropylene” and “propylene-based polymer” can be used interchangeably herein and refer to a polymer that comprises, in polymerized form, equal to or higher than 50 wt % or a majority weight percent of propylene (based on the weight of the polymer), and optionally may comprise one or more comonomers.

The term “polymeric monomer” as used herein refers to a monomeric unit of a polymer, the polymer generally being made up of a series of linked monomeric residues.

In some embodiments, the polyolefin can comprise one or more olefin-based polymers selected from polyethylene, polypropylene, polybutene, and any combination thereof.

In some embodiments, the polyolefin-based substrate film can comprise from 50% to 100%, from 55% to 100%, from 60% to 100%, or from 65% to 100% by weight of a polyethylene or a polypropylene, based on the total weight of the polyolefin-based substrate film.

In some embodiments, the polyolefin can comprise a polyethylene having an ethylene content of from 50% to 95%, from 55% to 95%, from 60% to 95%, from 65% to 95%, or from 70% to 95% by weight, based on the total weight of the ethylene-based polymer.

In some embodiments, the polyolefin can comprise a polypropylene having a propylene content of from 40 to 95%, from 45% to 95%, from 50% to 95%, from 55% to 95%, or from 60% to 95%, by weight, based on the total weight of the propylene-based polymer.

In some embodiments, the polyolefin-based substrate film can comprise from 40% to 95%, from 45% to 95%, from 50% to 95%, or from 55% to 95% by weight of ethylene polymeric monomers, based on the total weight of the polyolefin-based substrate film.

In some embodiments, the polyolefin-based substrate film can comprise from 40% to 95%, from 45% to 95%, from 50% to 95%, or from 55% to 95% by weight of propylene polymeric monomers, based on the total weight of the polyolefin-based substrate film.

The polyolefin can further comprise one or more co-monomers. In some embodiments, the co-monomers can be selected from the group consisting of ethylene, propylene, butene, hexene, octene, vinyl acetate, acrylic acid, methyl acrylic acid, methyl acrylate, ethyl acrylate, butyl acrylate, and any combination thereof. In some embodiments, the polyethylene can comprise one or more co-monomers selected from propylene, butene, hexene, octene, vinyl acetate, acrylic acid, methyl acrylic acid, methyl acrylate, ethyl acrylate, butyl acrylate, and any combination thereof. In some embodiments, the polypropylene can comprise one or more co-monomers selected from ethylene, butene, and any combination thereof.

In some embodiments, the polyolefin-based substrate film can have an average density of no less than 0.860 g/cm³, no less than 0.865 g/cm³, no less than 0.870 g/cm³, no less than 0.875 g/cm³, no less than 0.880 g/cm³, no less than 0.885 g/cm³, or no less than 0.890 g/cm³. In some embodiments, the polyolefin-based substrate film can have an average density of no more than 0.930 g/cm³, no more than 0.925 g/cm³, no more than 0.920 g/cm³, no more than 0.915 g/cm³, no more than 0.910 g/cm³, or no more than 0.905 g/cm³. In some embodiments, the polyolefin-based substrate film can have an average density that is within the numerical range obtained by combining any two of the following end points: 0.860, 0.865, 0.870, 0.875, 0.880, 0.885, 0.890, 0.895, 0.900, 0.905, 0.910, 0.915, 0.920, 0.925, and 0.930 g/cm³. In some embodiments, the polyolefin-based substrate film can have an average density of from 0.860 to 0.930 g/cm³, from 0.870 to 0.930 g/cm³, from 0.880 to 0.930 g/cm³, from 0.890 to 0.930 g/cm³, from 0.880 to 0.920 g/cm³, or from 0.890 to 0.920 g/cm³.

In some embodiments, the polyolefin-based substrate film can have a thickness of no less than 40 μm, no less than 45 μm, no less than 50 μm, no less than 55 μm, no less than 60 μm, no less than 65 μm, or no less than 70 μm. In some embodiments, the polyolefin-based substrate film can have a thickness of no more than 300 μm, no more than 250 μm, no more than 200 μm, no more than 180 μm, no more than 150 μm, no more than 120 μm or no more than 100 μm. In some embodiments, the polyolefin-based substrate film can have a thickness that is within the numerical range obtained by combining any two of the following end points: 40, 45, 50, 55, 60, 65, 70, 75, 80, 85, 90, 95, 100, 110, 120, 130, 140, 150, 180, 200, 220, 250, 280, and 300 μm. In some embodiments, the polyolefin-based substrate film can have a thickness of from 40 to 300 μm, for example, from 45 to 200 μm, from 50 to 200 μm, from 50 to 180 μm, from 50 to 150 μm, or from 50 to 120 μm.

In some embodiments, the polyethylene comprised in the polyolefin-based substrate film can have a Melt Index (MI) of no greater than 12 g/10 min, no greater than 11.5 g/10 min, no greater than 10 g/10 min, no greater than 9.5 g/10 min, or no greater than 9 g/10 min. In some embodiments, the polyethylene comprised in the polyolefin-based substrate film can have an MI of no less than 0.1 g/10 min, no less than 0.15 g/10 min, no less than 0.2 g/10 min, no less than 0.3 g/10 min, or no less than 0.5 g/10 min. In some embodiments, the polyethylene comprised in the polyolefin-based substrate film can have an MI that is within the numerical range obtained by combining any two of the following end points: 0.1, 0.15, 0.2, 0.3, 0.4, 0.5, 0.6, 0.8, 1, 1.5, 2, 2.5, 3, 3.5, 4, 4.5, 5, 5.5, 6, 6.5, 7, 7.5, 8, 8.5, 9, 9.5, 10, 10.5, 11, 11.5, and 12 g/10 min. In some embodiments, the polyethylene comprised in the polyolefin-based substrate film can have an MI of from 0.1 to 12 g/10 min, for example, from 0.2 to 12 g/10 min, from 0.5 to 12 g/10 min, from 0.1 to 10 g/10 min, from 0.2 to 10 g/10 min, from 0.5 to 10 g/10 min, from 0.2 to 8 g/10 min, from 0.5 to 8 g/10 min, from 0.2 to 5 g/10 min, or from 0.5 to 5 g/10 min. Generally, MI is measured under the condition of 190° C./2.16 kg, according to ASTM D 1238.

In some embodiments, the polypropylene comprised in the polyolefin-based substrate film can have a Melt Flow Rate (MFR) of no greater than 50 g/10 min, no greater than 45 g/10 min, no greater than 40 g/10 min, no greater than 35 g/10 min or no greater than 30 g/10 min. In some embodiments, the polypropylene comprised in the polyolefin-based substrate film can have an MFR of no less than 0.2 g/10 min, no less than 0.3 g/10 min, no less than 0.5 g/10 min, no less than 0.8 g/10 min, or no less than 1 g/10 min. In some embodiments, the polypropylene comprised in the polyolefin-based substrate film can have an MFR that is within the numerical range obtained by combining any two of the following end points: 0.2, 0.3, 0.5, 0.8, 1, 3, 5, 7, 10, 12, 15, 18, 20, 22, 25, 28, 30, 32, 35, 38, 40, 42, 45, 48 and 50 g/10 min. In some embodiments, the polypropylene comprised in the polyolefin-based substrate film can have an MFR of from 0.2 to 50 g/10 min, for example, from 0.5 to 50 g/10 min, from 0.8 to 50 g/10 min, from 1 to 50 g/10 min, from 2 to 50 g/10 min, from 0.5 to 45 g/10 min, from 0.5 to 40 g/10 min, from 0.8 to 40 g/10 min, from 1 to 40 g/10 min, from 1 to 30 g/10 min, or from 1 to 25 g/10 min. Generally, MFR is measured under the condition of 230° C./2.16 kg, according to ASTM D 1238.

The polyolefin-based substrate film can be a monolayer film or a multilayer film. The polyolefin-based substrate film can have a variety of thicknesses depending, for example, on the number of layers, the intended use of the film, and other factors.

In some embodiments, the polyolefin-based substrate film is a monolayer film.

In other embodiments, the polyolefin-based substrate film is a multilayer film comprising two or more layers of polyolefin-based substrate that are typically included in multilayer films depending on the application including, for example, skin layers, core layers, sealant layers, barrier layers, tie layers, other polyolefin layers etc. In some embodiments, the two or more layers of polyolefin-based substrate can be of the same or different materials. In some embodiments, each of the two or more layers of polyolefin-based substrate can have a thickness of from 5 to 100 microns, for example, from 5 to 80, from 5 to 60, from 5 to 50, from 10 to 50 microns. In an exemplary embodiment, a multilayer polyolefin-based substrate film comprises a skin layer, a sealant layer and a core layer sandwiched between the skin layer and the sealant layer. Generally, the outer layers (such as skin layers, sealant layers), if present, are thinner than the inner layers (such as core layers).

The polyolefin-based substrate film, as described herein, can further comprise one or more additives as known to those of skill in the art, such as, for example, one or more selected from antioxidants, ultraviolet light stabilizers, thermal stabilizers, slip agents, antiblock, pigments or colorants, processing aids, crosslinking catalysts, flame retardants, and fillers.

ii. Polyurethane-Based Top Coating

The polyurethane-based top coating is formed essentially of polyurethane. In some embodiments, the polyurethane-based top coating comprises from 80% to 100%, for example, from 85% to 100%, from 90% to 100%, from 95% to 100%, or from 98% to 100% by weight of polyurethane, based on the total weight of the polyurethane-based top coating.

In some embodiments, the polyurethane-based top coating can comprise a polyurethane composition comprising a hydroxyl-terminated component and an isocyanate-terminated component. In some embodiments, the polyurethane-based top coating can be prepared from the polyurethane composition by mixing the hydroxyl-terminated component and the isocyanate-terminated component.

In some embodiments, the hydroxyl-terminated component and the isocyanate-terminated component can be solventless or solvent-based.

In some embodiments, the polyurethane composition can be solventless. As used herein, the term “solventless” means that the polyurethane composition can be applied (for example, up to one hundred percent solids) without either organic solvent or an aqueous carrier. In some embodiments of the present disclosure, the polyurethane composition comprises less than 4% by weight, less than 3% by weight, less than 2% by weight, less than 1% by weight, less than 0.5% by weight, less than 0.2% by weight, less than 0.1% by weight, less than 100 ppm by weight, less than 50 ppm by weight, less than 10 ppm by weight, less than 1 ppm by weight of any organic or inorganic solvent or water, or is free of any organic or inorganic solvent or water.

In some embodiments, the polyurethane composition can be solvent-based. As disclosed herein, the term “solvent” refers to organic and inorganic liquids whose function is solely dissolving one or more solid, liquid or gaseous materials without incurring any chemical reaction. In some embodiments, the solvent can be an organic solvent. Common suitable organic solvents can include acetone, methyl ethyl ketone (MEK), ethyl acetate, toluene, cyclohexane, any mixture thereof, and the like, preferably moisture-free to prevent premature reaction of the isocyanate groups of the polyurethane. In some embodiments, the solvent can be selected from the group consisting of acetone, methyl ethyl ketone (MEK), ethyl acetate, toluene, hexane, and any combinations thereof.

In some embodiments, the NCO/OH ratio of the isocyanate-terminated component and the hydroxyl-terminated component can be within the range of from 1:1 to 3:1, from 1.2:1 to 3:1, from 1.5:1 to 3:1, from 1:1 to 2.5:1, from 1:1 to 2:1, from 1:1 to 1.8:1, or from 1:1 to 1.5:1. As used herein, the term “NCO/OH ratio” refers to the ratio of the number of isocyanate groups to the number of hydroxyl groups in the mixture of the isocyanate component and the polyol component, or the isocyanate component and the polyol component together before mixing.

In some embodiments, the hydroxyl-terminated component used for forming the polyurethane-based top coating can comprise one or more polyether polyols, one or more polyester polyols, a hydroxyl terminated reaction product of one or more isocyanate compounds and one or more polyols selected from polyester polyols, polyether polyols, or combination thereof. In some embodiments, the hydroxyl-terminated component comprises a hydroxyl-terminated reaction product that is a hydroxyl-terminated urethane prepolymer. In some embodiments, the hydroxyl-terminated urethane prepolymer can be prepared from one or more (e.g., two or more) polyols selected from polyether polyols, polyester polyols, or combination thereof, and one or more isocyanate monomers, as described herein.

As used herein, the term “polyol” refers to a compound with two or more hydroxyl groups. A polyol with exactly two hydroxyl groups is a “diol.” A polyol with exactly three hydroxyl groups is a “triol.” A polyol with exactly four hydroxyl groups is a “tetraol.” In some embodiments, the one or more polyols comprise one or more diols, triols, tetraols and any combination thereof.

A compound that contains two or more ether linkages in the same linear chain of atoms is known herein as a “polyether.” A compound that is a polyether and a polyol is a “polyether polyol.” In some embodiments, the polyether polyols can have a molecular weight not to exceed 10,000 g/mol. In some embodiments, the polyether polyols can have a hydroxyl group functionality of at least 1.5 (i.e., f≥ 1.5).

Polyether polyols suitable for use according to this disclosure can be the polyaddition products of ethylene oxide, propylene oxide, tetrahydrofuran, butylene oxide, and the co-addition and grafted products thereof, as well as the polyether polyols obtained by condensation of polyhydric alcohols, or mixtures thereof. Examples of polyether polyols suitable for use include, but are not limited to, polypropylene glycol (“PPG”), polyethylene glycol (“PEG”), polybutylene glycol, and polytetramethylene ether glycol (“PTMEG”).

A compound that contains two or more ester linkages in the same linear chain of atoms is known herein as a “polyester.” A compound that is a polyester and a polyol is known herein as a “polyester polyol.” In some embodiments, the polyester polyols can have a molecular weight not to exceed 10,000 g/mol. In some embodiments, the polyester polyols can have a hydroxyl group functionality of at least 1.5 (i.e., f≥ 1.5). In some embodiments, the polyester polyols can have a hydroxyl group functionality not to exceed 10 (i.e., f≤ 10), for example, not to exceed 8, or not to exceed 6.

Polyester polyols suitable for use according to this disclosure include, but are not limited to, polycondensates of diols and also, optionally, polyols (e.g., triols, tetraols), and of dicarboxylic acids and also, optionally, polycarboxylic acids (e.g., tricarboxylic acids, tetracarboxylic acids) or hydroxycarboxylic acids or lactones. The polyester polyols can also be derived from, instead of the free polycarboxylic acids, the corresponding polycarboxylic anhydrides, or corresponding polycarboxylic esters of lower alcohols.

Suitable diols include, but are not limited to, ethylene glycol, butylene glycol, diethylene glycol, triethylene glycol, pentylene glycol, hexalene glycol, polyalkylene glycols, such as polyethylene glycol, and also 1,2-propanediol, 1,3-propanediol, 1,3-butanediol, 1,4-butanediol, 1,6-hexanediol, and neopentyl glycol. In order to achieve a polyester polyol functionality greater than 2, polyols having a functionality of 3 can optionally be included in the adhesive composition (e.g., trimethylolpropane, glycerol, erythritol, pentaerythritol, trimethylolbenzene or trishydroxyethyl isocyanurate).

Suitable dicarboxylic acids include, but are not limited to, aliphatic acids, aromatic acids, and combinations thereof. Examples of suitable aromatic acids include phthalic acid, isophthalic acid, terephthalic acid, and tetrahydrophthalic acid. Examples of suitable aliphatic acids include hexahydrophthalic acid, cyclohexane dicarboxylic acid, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid, 2,2-dimethyl succinic acid, and trimellitic acid. As used herein, the term “acid” also includes any anhydrides of said acid. Further, monocarboxylic acids, such as benzoic acid and hexane carboxylic acid, should be minimized or excluded from the disclosed compositions. Saturated aliphatic and/or aromatic acids are also suitable for use according to this disclosure, such as adipic acid or isophthalic acid.

In some embodiments, one or more of the polyester polyols used in the hydroxyl-terminated component can be replaced by one or more polyols selected from the group consisting of polycarbonate polyol, polycaprolactone polyol, other polymers terminated with hydroxyl group, and the combination thereof.

In the embodiments where the hydroxyl-terminated component comprises a hydroxyl terminated reaction product (for example, a hydroxyl-terminated urethane prepolymer) of one or more polyols and one or more isocyanate compounds, the one or more polyols can be selected from the described polyester polyols, polyether polyols or combination thereof, and, the one or more isocyanate compounds are those reactive with the selected polyol(s) and can be selected from isocyanate monomers, modified isocyanates and combination thereof, as described herein. In an embodiment, the hydroxyl-terminated urethane prepolymer is prepared from at least one (e.g., one, two, three, four or five) polyether polyol (e.g., diol, triol, tetraol or their mixture), and at least one (for example, one, two, three, four or five) isocyanate monomer.

In an embodiment, the one or more polyols used according to the present disclosure can have a weight average molecular weight (Mw) within the numerical range obtained by combining any two of the following end points: 120, 200, 250, 300, 350, 400, 450, 500, 600, 700, 800, 900, 1000, 1200, 1500, 1800, 2000, 2200, 2500, 2800, 3000, 3200, 3500, 3800, 4000, 4200, 4500, 4800, 5000, 5200, 5500, 5800, 6000, 6200, 6500, 6800, 7000, 7200, 7500, 7800, 8000, 8200, 8500, 8800, 9000, 9200, 9500, 9800, and 10000 g/mol. In an embodiment, the one or more polyols can have an Mw of no less than 200 g/mol, for example, no less than 250 g/mol, or no less than 300 g/mol. In an embodiment, the one or more polyols can have an Mw of no more than 5000 g/mol, for example, no more than 3000 g/mol, or no more than 2000 g/mol. In an embodiment, the one or more polyols can have an Mw ranged from 200 to 8000 g/mol, for example, from 250 to 6000 g/mol, from 300 to 3000 g/mol, from 350 to 2000 g/mol, or from 350 to 1800 g/mol.

In an embodiment, the one or more polyols used according to the present disclosure can have a hydroxyl group functionality within the numerical range obtained by combining any two of the following end points: 2, 3, 4, 5, 6, and 7. In an embodiment, the one or more polyols used according to the present disclosure can have a hydroxyl group functionality of no more than 7, no more than 6, no more than 5, or no more than 4. In an embodiment, the one or more polyols used according to the present disclosure can have a hydroxyl group functionality of from 2 to 7, for example, 2 to 6, 2 to 5, or 2 to 4.

In an embodiment, the one or more polyols used according to the present disclosure can have a hydroxyl group number within the numerical range obtained by combining any two of the following end points: 80, 100, 110, 120, 130, 150, 170, 200, 220, 240, 260, 280, 300, 350, 400, 450, 500, 600, 700, 800, 900 and 1000 mg KOH/g. In an embodiment, the one or more polyols used according to the present disclosure can have a hydroxyl group number that is no higher than 1000 mg KOH/g, for example, no higher than 800 mg KOH/g, no higher than 600 mg KOH/g, or no higher than 500 mg KOH/g. In an embodiment, the one or more polyols used according to the present disclosure can have a hydroxyl group number of from 100 to 600 mg KOH/g, from 100 to 500 mg KOH/g, or from 100 to 400 mg KOH/g.

As used herein, an “isocyanate monomer” is any compound that contains two or more isocyanate groups. An “aromatic isocyanate” is an isocyanate that contains one or more aromatic rings. An “aliphatic isocyanate” contains no aromatic rings.

Isocyanate monomers suitable for use according to the disclosure can be selected from the group consisting of aromatic isocyanates, aliphatic isocyanates, carbodiimide modified isocyanates, and the combinations thereof. Examples of aromatic isocyanates suitable for use according to the disclosure include, but are not limited to, isomers of methylene diphenyl dipolyisocyanate (“MDI”) such as 4,4-MDI, 2,4-MDI and 2,2′-MDI, or modified MDI such as carbodiimide modified MDI or allophanate modified MDI; isomers of toluene-dipolyisocyanate (“TDI”) such as 2,4-TDI, 2,6-TDI, isomers of naphthalene-dipolyisocyanate (“NDI”) such as 1,5-NDI, and the combinations thereof. Examples of aliphatic isocyanates suitable for use according to this disclosure include, but are not limited to, isomers of hexamethylene dipolyisocyanate (“HDI”), isomers of isophorone dipolyisocyanate (“IPDI”), isomers of xylene dipolyisocyanate (“XDI”), isomers of methylene-bis-(4-cyclohexylisocyanate) (“HMDI”), and the combinations thereof. In some embodiments, the isocyanate monomers comprises diisocyanate monomers selected from the group consisting of isophorone diisocyanate (IPDI), methylene-bis-(4-cyclohexylisocyanate) (HMDI), hexamethylene diisocyanate (HDI), methylene diphenyl diisocyanate (MDI), toluene diisocyanate (TDI), and the combination thereof.

In some embodiments, the hydroxyl-terminated component can be solvent-based. In some embodiments, the hydroxyl-terminated component can further comprises ingredient(s) selected from one or more of catalysts, surfactants, preservatives, pigments, flame retardants, colorants, antioxidants, biological retarding agents, reinforcing agents, antifoaming agents, stabilizers, and any combination thereof, as described herein.

Examples of suitable catalysts that may tend to favor the urethane reaction include, generally, amidines, tertiary amines, organometallic compounds, and combinations thereof. These may include, but are not limited to, amidines such as 1,8-diazabicyclo[5.4.0]undec-7-ene and 2,3-dimethyl-3,4,5,6-tetrahydropyrimidine, and tertiary amines such as triethylamine, tributylamine, dimethylbenzylamine, N-methyl-, N-ethyl-, and N-cyclohexylmorpholine, N,N,N′,N′-tetramethylethylenediamine, N,N,N′,N′-tetramethylbutanediamine and -hexanediamine, pentamethyldiethylenetriamine, tetramethyldiaminoethyl ether, bis(dimethylaminopropyl)urea, dimethylpiperazine, dimethylcyclohexylamine, 1,2-dimethyl-imidazole, l-aza-bicyclo[3.3.0]octane, and, in some preferred embodiments, 1,4-diazabicyclo[2.2.2]octane. Alkanolamine compounds, such as triethanolamine, triisopropanolamine, N-methyl- and N-ethyldiethanolamine, and dimethylethanolamine, may also be selected. Combinations of any of the above may also be effectively employed.

In some embodiments, the viscosity of the hydroxyl-terminated component can be in the range of from 1000 cps to 4000 cps, for example, from 1500 cps, 1800 cps, 2000 cps, 2200 cps, or 2500 cps, to 2800 cps, 3000 cps, 3200 cps, 3500 cps, or 4000 cps, measured at 25° C. Preferably, the viscosity of the hydroxyl-terminated component is ranged from 2000 cps to 3500 cps, and more preferably from 2500 cps to 3500 cps, measured by ASTM 4878-15.

In some embodiments, the hydroxyl-terminated component can have a solid content of no less than 50%, no less than 55%, no less than 60%, or no less than 65%, based on the total weight of the hydroxyl-terminated component.

In some embodiments, the isocyanate-terminated component used for forming the polyurethane-based top coating can comprise one or more selected from isocyanate monomers, modified isocyanates, and combination thereof, as described herein. In further embodiments, the isocyanate-terminated component can comprise an isocyanate-terminated urethane prepolymer that is the reaction product of one or more isocyanate monomers and one or more polyols, as described herein.

In some embodiments, the hydroxyl-terminated component can be solvent-based. In some embodiments, the hydroxyl-terminated component can further comprises ingredient(s) selected from one or more of catalysts, surfactants, preservatives, pigments, flame retardants, colorants, antioxidants, biological retarding agents, reinforcing agents, antifoaming agents, stabilizers, and any combination thereof, as described herein.

In some embodiments, the viscosity of the isocyanate-terminated component can be in the range of from 100 to 1000 cps, for example, from 100 cps, 120 cps, 150 cps, or 180 cps, to 200 cps, 250 cps, 300 cps, 350 cps, 400 cps, 500 cps, 600 cps, 700 cps, 800 cps, 900 cps or 1000 cps. Preferably, the viscosity of the isocyanate-terminated component is ranged from 120 cps to 500 cps, and more preferably from 150 cps to 400 cps, measured by ASTM 4878-15.

In some embodiments, the isocyanate-terminated component can have a solid content of no less than 40%, no less than 45%, no less than 50%, no less than 55%, or no less than 60%, based on the total weight of the isocyanate-terminated component.

In some embodiments, the coating weight (e.g., dry coating weight) of the polyurethane-based top coating can be varied within the numerical range obtained by combining any two of the following end points: 0.5, 0.8, 1.0, 1.5, 1.8, 2.0, 2.2, 2.5, 3.0, 3.5, 4.0 and 4.5 gsm. In some embodiments, the coating weight (dry coating weight) of the polyurethane-based top coating can be varied from 0.5 gsm to 4.5 gsm, from 0.8 gsm to 4.0 gsm, from 1.0 gsm to 4.0 gsm, from 0.5 gsm to 2.5 gsm, for example, from 0.8 gsm to 2.2 gsm, or, from 1.0 gsm to 2.0 gsm.

In an embodiment, the polyurethane-based top coating can be formed by mixing the isocyanate-terminated component with the hydroxyl-terminated component as described, and coating the mixture in the form of a layer, for example, onto the polyolefin-based substrate film according to the present disclosure.

In some embodiments, the hydroxyl-terminated component and the isocyanate-terminated component can be mixed at a weight ratio of from 0.2:1, 0.4:1, 0.5:1, 0.8:1, or 1:1 to 1.2:1, 1.5:1, 1.8:1, 2:1, 2.5:1, 3:1, 3.5:1, 4:1 or 5:1.

In some embodiments, the polyurethane-based top coating can further comprise one or more auxiliary agents and/or additives selected from the group consisting of other co-catalysts, surfactants, toughening agents, flow modifiers, diluents, stabilizers, plasticizers, catalyst de-activators, dispersing agents, colorants, and mixtures thereof.

It is found that the laminate according to the present disclosure provides improved balancing of performances including good softness, clarity and scratch resistance, with reduced chloride content.

In some embodiments, the laminate according to the present disclosure is chloride free. As used herein, the term “chloride free” refers to a laminate that do not contain chloride or contains lower than 0.01, or lower than 0.001, or lower than 0.0001 by weight of chloride, based on the total weight of the laminate.

In some embodiments, the laminate according to the present disclosure has a Zebedee clarity of at least 25%, or preferably at least 28%, when measured by a Zebedee® CL-100 Clarity Meter, in accordance with ASTM D1746/15.

In some embodiments, the laminate according to the present disclosure has a tensile modulus of no higher than 220 MPa, or preferably no higher than 210 MPa, as measured in accordance with ASTM D882. In some embodiments, the laminate according to the present disclosure has a tensile modulus of no lower than 130 MPa, or preferably no lower than 140 MPa, as measured in accordance with ASTM D882. In some embodiments, the laminate according to the present disclosure has a tensile modulus that is within the numerical range obtained by combining any two of the following end points: 120, 130, 140, 150, 160, 170, 180, 190, 200, 210, 220, and 230 MPa. In some embodiments, the laminate according to the present disclosure has a tensile modulus that is in the range of from 120 MPa, 130 MPa, 140 MPa, or 150 MPa, to 200 MPa, 210 MPa, 220 MPa or 230 MPa.

### B. Preparation of the Laminates

The present disclosure further provides a method of preparing a laminate as described herein, comprising: (1) providing a polyolefin-based substrate film having a first inner surface and a first outer surface; (2) mixing an isocyanate-terminated component and a hydroxyl-terminated component to form a mixture; and (3) coating, on the first inner surface, the mixture obtained in step (2), to form a layer of the polyurethane-based top coating having a second inner surface and a second outer surface.

The polyolefin-based substrate film is as described herein and can be provided in the form of a monolayer film or a multilayer film. In some embodiments, the polyolefin-based substrate film is a monolayer film. In other embodiments, the polyolefin-based substrate film is a multilayer film comprising two or more layers of polyolefin-based substrate that are typically included in multilayer films depending on the application including, for example, skin layers, core layers, sealant layers, barrier layers, tie layers, other polyolefin layers etc. In some embodiments, the two or more layers of polyolefin-based substrate can be of the same or different materials. In some embodiments, each of the two or more layers of polyolefin-based substrate can have a thickness of from 5 to 100 microns, for example, from 5 to 80, from 5 to 60, from 5 to 50, from 10 to 50 microns. In an exemplary embodiment, a multilayer polyolefin-based substrate film comprises a skin layer, a sealant layer and a core layer sandwiched between the skin layer and the sealant layer.

The layers of the polyolefin-based substrate film can be formed with the same or different polyolefins as described herein. Generally, the outer layers (such as skin layers, sealant layers), if present, are thinner than the inner layers (such as core layers).

Multilayer films that can be used as the polyolefin-based substrate film in the laminate can be formed using techniques know to those of skill in the art based on the teachings herein. For example, for those layers that can be coextruded, such layers can be coextruded as blown films or cast films using techniques known to those of skill in the art based on the teachings herein. In particular, based on the compositions of the different film layers disclosed herein, blown film manufacturing lines and cast film manufacturing lines can be configured to coextrude multilayer films of the present disclosure in a single extrusion step using techniques known to those of skill in the art based on the teachings herein.

The polyurethane-based top coating is as described herein and can be provided by mixing a hydroxyl-terminated component and an isocyanate-terminated component as described. In some embodiments, the mixture can be prepared by mixing the hydroxyl-terminated component and the isocyanate-terminated component at an NCO/OH ratio of from 1:1 to 3:1.

In some embodiments, the mixture formed by mixing the hydroxyl-terminated component and the isocyanate-terminated component can be diluted with a solvent, for example, the same solvent as used in the hydroxyl-terminated component and the isocyanate-terminated component, or, an organic solvent selected from the group consisting of acetone, methyl ethyl ketone (MEK), ethyl acetate, toluene, hexane, and any combinations thereof, to obtain a diluted mixture having solid content of from 20% to 50%, based on the total weight of the diluted mixture.

In some embodiments, the coating weight (dry coating weight) of the polyurethane-based top coating can be varied within the numerical range obtained by combining any two of the following end points: 0.5, 0.8, 1.0, 1.5, 1.8, 2.0, 2.2, 2.5, 3.0, 3.5, 4.0 and 4.5 gsm. In some embodiments, the coating weight (dry coating weight) of the polyurethane-based top coating can be varied from 0.5 gsm to 4.5 gsm, from 0.8 gsm to 4.0 gsm, from 1.0 gsm to 4.0 gsm, from 0.5 gsm to 2.5 gsm, for example, from 0.8 gsm to 2.2 gsm, or, from 1.0 gsm to 2.0 gsm.

The mixture of the hydroxyl-terminated component and the isocyanate-terminated component can be applied onto the polyolefin-based substrate film by gravure, flexographic or smooth roll method, or any other method known in the art, to form the polyurethane-based top coating.

In some embodiments, the method of preparing the laminate of the present disclosure further comprises evaporating the solvents from the polyurethane-based top coating or allowing the solvents to evaporate.

In some embodiment, the method of preparing the laminate of the present disclosure further comprises curing the polyurethane-based top coating or allowing it to cure. The laminate coating may be cured at a suitable curing temperature, for example, from 25° C. to 60° C.

### C. Application of the Laminate

The present disclosure further provides an article comprising the laminate described herein.

The present disclosure further provides use of the laminate described herein in the packaging of a product.

### EXAMPLES

Some embodiments of the invention will now be described in the following Examples, wherein all parts and percentages are by weight unless otherwise specified. However, the scope of the present disclosure is not, of course, limited to the formulations set forth in these examples. Rather, the Examples are merely inventive of the disclosure.

The inventive and comparative structures are listed in Table 1.

TABLE 1
Structural information of sample films

| Samples | Structure |
|---|---|
| Inventive-1 | PU coating/Polyolefin film #1 |
| Inventive-2 | PU coating/Polyolefin film #2 |
| Comparative-1 | PVC film 50 μm |
| Comparative-2 | Polyolefin film #1 |
| Comparative-3 | Polyolefin film #2 |

TABLE 2
Formulation of polyolefin film #1

| Skin layer | Core Layer | Sealant layer |
|---|---|---|
| 15 micron 100% | 50 micron 100% | 15 micron 100% |
| Dowlex 2047G | Engage 7256 | Dowlex 2047G |

Engage 7256: 2.5MI, 0.885 g/cm³ density, ethylene-butene copolymer, ethylene content 79% wt.

Dowlex 2047G: 2.3MI, 0.917 g/cm³ density. Ethylene-octene copolymer, ethylene content 88 wt %.

TABLE 3
Formulation of polyolefin film #2

| Skin layer | Core Layer | Sealant layer |
|---|---|---|
| 10 micron 100% | 30 micron 100% | 10 micron 100% |
| Dowlex 2047G | Dowlex 2047G | Dowlex 2047G |

With regard to the polyurethane-based top coating, illustrative solvent-based hydroxyl-terminated component and isocyanate-terminated component were prepared as follows.

TABLE 4
Isocyanate-terminated component for Polyurethane coating

| | | Amount |
|---|---|---|
| Ingredient | Description | (wt. %) |
| Ethyl acetate | Solvent from UNIVAR, Inc. | 24.049 |
| Trimethylolpropane | from Lanxess Corp, functionality = 3 | 11.480 |
| Monomeric toluene | Mondur TD-80 Grade B from Covestro | 43.612 |
| diisocyanate (TDI) | | |
| Wax Ester | Synaceti 125 from Werner G. Smith, Inc. | 1.191 |
| Corn oil | Fatty triglyceride, refined corn oil | 1.191 |
| | from Cargill Inc. | |
| Cyclohexane | Cyclohexane from UNIVAR, Inc. | 18.423 |
| Benzoyl chloride | benzoyl chloride from Aldrich | 0.055 |
| | Chemical Co. | |

Procedures: the wax ester and the trimethylolpropane were loaded to the reactor followed by ethyl acetate. The TDI was vacuum loaded to the reactor followed by the remainder of the ethyl acetate as a rinse. The batch was held at 70° C. for 3 hours. The batch was then cooled to 55° C. The viscosity of the batch was measured. If the viscosity was less than 380 mPa*s (380 cP), the viscosity of the batch was adjusted to 380 mPa*s (380 cP) by adding trimethylolpropane. If the viscosity was greater than 380 mPa*s (380 cP), or after the additional trimethylolpropane was added, the reactor was then cooled to 55° C. The corn oil was vacuum loaded to the reactor. The cyclohexane was then added to the reactor, and the contents were held at 45° C. and stirred 45 minutes until the contents became clear. The benzoyl chloride was then vacuum-loaded to the reactor, and the contents were stirred for 15 minutes. The obtained composition was then stored for use.

TABLE 5
Hydroxyl-terminated component for Polyurethane coating

| | | Amount |
|---|---|---|
| Ingredient | Description | (wt. %) |
| Ethyl acetate | Solvent from UNIVAR, Inc. | 26.5861 |
| Triisopropylanol- | polyol from The Dow Chemical Company; | 20.2901 |
| amine (TIPA) | MW = 191; functionality: 3 | |
| Monomeric toluene | Mondur TD-80 Grade B from Covestro | 17.8299 |
| diisocyanate (TDI) | | |
| Voranol ™ | polyether diol (nominal molecular weight | 13.8618 |
| 220-260 | of 425), functionality = 2, OHN = 260 | |
| | from The Dow Chemical Company | |
| Voranol ™ | Polyether polyol, MW = 1000; Function- | 21.4276 |
| 220-110N | ality: 2; OHN = 110 from The Dow | |
| | Chemical Company | |
| SAG-47 | Anti foam from Momentive Performance | 0.0046 |
| | Materials | |

Procedures: the TIPA was melted. The Voranol 220-260 was vacuum loaded into a reactor. The melted TIPA was vacuum loaded into the reactor, followed by the VORANOL 220-110N. The vacuum lines were rinsed with ethyl acetate and the contents of the reactor were stirred at 75 RPM. Ethyl acetate was vacuum loaded into the reactor. The contents of the reactor were cooled via a cooling jacket. After cooling, the TDI was loaded to the reactor, and the vacuum lines were rinsed with ethyl acetate. Because of the exothermic nature of the reaction, the contents of the reactor were cooled to a temperature of 75° C. The temperature in the reactor was held at 75° C. under agitation for 4 hours. The contents of the reactor were then cooled to 60° C., a mixture of the antifoam and the remaining ethyl acetate were vacuum loaded to the reactor. The contents were then stirred for 30 minutes. The reactor was then cooled to 50° C. The obtained composition was then stored for use.

The properties of the hydroxyl-terminated component and the isocyanate-terminated component are summarized as follows.

TABLE 6
The properties of the hydroxyl-terminated component
and the isocyanate-terminated component

| | Hydroxyl-terminated | | Isocyanate-terminated | |
|---|---|---|---|---|
| Property | component | | component | |
| Viscosity (25° C.) | 3000 | cps | 200 | cps |
| Density | 1.03 | g/cm³ | 1.03 | g/cm³ |
| Solvent | Ethyl Acetate | | Ethyl Acetate | |
| | | | and Cyclohexane | |
| Mix ratio | 50 | ppw | 50 | ppw |

| | | |
|---|---|---|
| Diluents | Urethane grade | Urethane grade |
| | Ethyl acetate | Ethyl acetate |

The isocyanate-terminated component and diluents solvent were weighed out and mixed thoroughly. The hydroxyl-terminated component was weighted out and added to the pre-diluted isocyanate-terminated component, before thoroughly mixing until a clear solution was obtained, to produce a diluted polyurethane solution. The polyurethane solution was obtained closely prior to (within 20 min before) applying the polyurethane coating for lamination.

The polyurethane coating was conducted on a Nordmeccanica Labo Combi 400 pilot coater using a rotogravure cylinder. The processing parameters are listed below:

TABLE 7
The processing parameters of PU coating

| Processing Parameters | PU coating |
|---|---|
| Adhesive running solid | 25% |
| Dry coating weight | 1.8 gsm |
| Drying condition | 3 oven zones with increase profile |
| | setting 55° C.,65° C.,75° C. |
| Curing Condition of the laminate | 25° C., 7 days |

### Results and Discussion

TABLE 8
Performance evaluation results:

| | | | | PU | Comparative-1 | Comparative-2 | Comparative-3 |
|---|---|---|---|---|---|---|---|
| | PU coating// | | | coating// | PVC film from | Polyolefin film | Polyolefin film |
| | Polyolefin 1# | | | Polyolefin 2# | market | 1# alone | 2# alone |
| PU Coating | 1.0 | 1.8 | 4.0 | 1.0 | 0 | 0 | 0 |
| weight, gsm | | | | | | | |
| Scratch | Good | Good | Good | Good | Good | Poor | Poor |
| resistance | | | | | | | |
| Zebedee | 34.4 | 29.9 | 33.4 | 38.9 | 22 | 41.6 | 38.9 |
| clarity, % | | | | | | | |
| Softness by | 142.08 | 152.33 | 206.62 | 199.5 | 197 | 123.86 | 173.2 |
| modulus | | | | | | | |
| (Tensile | | | | | | | |
| modulus, | | | | | | | |
| Mpa) | | | | | | | |

The lab pilot coater trial and evaluation results suggest that the inventive laminate can deliver a chloride free packaging solution for garment/stationary packaging, to meet the demanding requirement to replace the existing PVC solution.

The inventive laminate can resolve the poor scratch resistance of the incumbent polyolefin film, meanwhile achieve better clarity/softness vs. PVC films.

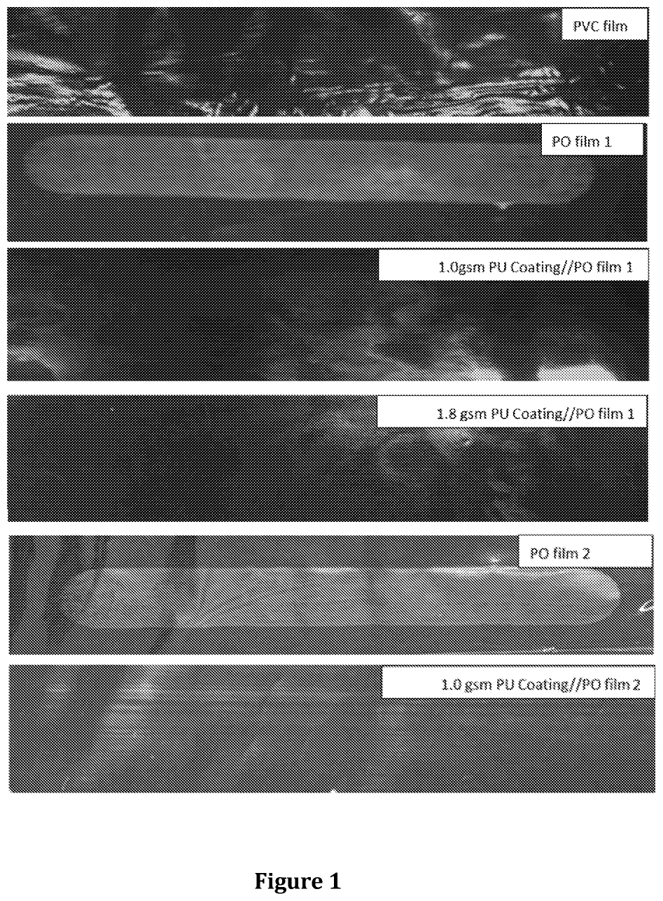

The following groups of samples were tested for their scratch resistance and the results are shown in FIG. 1:
1. PVC: almost no damage after scratch test;
2. Polyolefin film #1 alone: heavy damage after scratch test;
3. 1.0 gsm PU coating+Polyolefin film #1: almost no damage after scratch test;
4. 1.8 gsm PU coating+Polyolefin film #1: almost no damage after scratch test;
5. Polyolefin film #2 alone: heavy damage after scratch test;
6. 1.0 gsm PU coating+Polyolefin film #2: very light damage after scratch test.

### Test Methods:

### 1. Scratch Resistance

The scratch resistance was done with a Sutherland Ink Rub Tester. The film samples were Cut into 20 cm*5 cm sheet, then put it under a paper supports against 500 gram weight, run rubbing of 30 seconds to check the scratch damage. Lighter damage represents better scratch resistance.

### 2. Clarity

The film clarity was measure by a Zebedee® CL-100 Clarity Meter.

### 3. Modulus

The Modulus was measured/calculated in accordance with ASTM D882-18 Standard Test Method for Tensile Properties of Thin Plastic Sheeting.

What is claimed is:

1. A laminate, comprising:
a polyolefin-based substrate film having a first inner surface and a first outer surface, and
a polyurethane-based top coating having a second inner surface and a second outer surface,
wherein the first inner surface is in contact with the second inner surface,
wherein the polyurethane-based top coating is formed by mixing an isocyanate-terminated component and a hydroxyl-terminated component and coating the mixture onto the first inner surface of the polyolefin-based substrate film, and
wherein the laminate has a Zebedee clarity of no lower than 25% as measured in accordance with ASTM D1746/15, and a tensile modulus of no higher than 230 MPa as measured in accordance with ASTM D882.

2. The laminate of claim 1, wherein the laminate is chloride free.

3. The laminate of claim 1, wherein the polyolefin comprises one or more olefin-based polymers selected from polyethylene, polypropylene, polybutene, and any combination thereof.

4. The laminate of claim 1, wherein the polyolefin-based substrate film has an average density of no more than 0.930 g/cm³.

5. The laminate of claim 1, wherein the viscosity of the hydroxyl-terminated component is ranged from 2000 cps to 3500 cps, and the viscosity of the isocyanate-terminated component is ranged from 120 cps to 500 cps, measured by ASTM 4878-15.

6. The laminate of claim 1, wherein the isocyanate-terminated component and the hydroxyl-terminated component are mixed at an NCO/OH ratio of from 1:1 to 3:1.

7. The laminate of claim 1, wherein the hydroxyl-terminated component and the isocyanate-terminated component are solvent-based.

8. The laminate of claim 7, wherein the solvent includes acetone, methyl ethyl ketone (MEK), ethyl acetate, toluene, cyclohexane, or any mixture thereof.

9. The laminate of claim 1, wherein the polyolefin-based substrate film is a monolayer film or a multilayer film.

10. A method of preparing the laminate of claim 1, comprising:
(1) providing the polyolefin-based substrate film having a first inner surface and a first outer surface;
(2) mixing the isocyanate-terminated component and the hydroxyl-terminated component to form a mixture; and
(3) coating, on the first inner surface, the mixture obtained in step (2), to form a layer of the polyurethane-based top coating having a second inner surface and a second outer surface.

11. The method of claim 10, wherein the hydroxyl-terminated component and the isocyanate-terminated component are mixed at an NCO/OH ratio of from 1:1 to 3:1 to form the polyurethane-based top coating.

12. The method of claim 10, wherein the viscosity of the hydroxyl-terminated component is ranged from 2000 cps to 3500 cps, and the viscosity of the isocyanate-terminated component is ranged from 120 cps to 500 cps, measured by ASTM 4878-15.
